(19) United States
(12) Patent Application Publication
(10) Pub. No.: US 2026/0107368 A1
(43) Pub. Date: Apr. 16, 2026

(54) EXTREME ULTRA-VIOLET (EUV) LIGHT SOURCE APPARATUS

(71) Applicant: Samsung Electronics Co., Ltd., Suwon-si (KR)

(72) Inventors: Daegeun Yoon, Suwon-si (KR); Sunghyup Kim, Suwon-si (KR); Injae Lee, Suwon-si (KR); Seungpyo Hong, Suwon-si (KR)

(21) Appl. No.: 19/053,818

(22) Filed: Feb. 14, 2025

(30) Foreign Application Priority Data
Oct. 14, 2024 (KR) 10-2024-0139728

(51) Int. Cl. H05G 2/00

(52) U.S. Cl. CPC H05G 2/0094

(57) ABSTRACT

An extreme ultra-violet (EUV) light source apparatus includes a chamber body, a reflector, a plurality of gas injection holes, and a plurality of spitting suppression structures. The chamber body has an internal wall and an outer wall. The reflector is under the chamber body and is configured to focus EUV light. The plurality of gas injection holes extend from the outer wall of the chamber body to the internal wall of the chamber body. The plurality of spitting suppression structures are on the internal wall of the chamber body, and are configured to suppress spitting of debris. Each of the plurality of spitting suppression structures includes: a porous structure including a plurality of pores and a plurality of nodes; a plurality of fixing pins fixed to the internal wall of the chamber body, and spaced apart from the porous structure to an outer side of the porous structure; and a plurality of connection members each connected to a respective one of the nodes and a respective one of the fixing pins.

### CROSS-REFERENCE TO RELATED APPLICATION

This application is based on and claims priority under 35 U.S.C. § 119 to Korean Patent Application No. 10-2024-0139728, filed on Oct. 14, 2024 in the Korean Intellectual Property office, the disclosure of which is incorporated by reference herein in its entirety.

### FIELD

The application relates to an extreme ultra-violet (EUV) light source apparatus, and more particularly, to an EUV light source apparatus which generates EUV light by using tin plasma.

### BACKGROUND

According to high integration and miniaturization of semiconductor devices, technology for forming very small circuit patterns is required. To meet these technical requirements, an exposure process using EUV light is used. To generate the EUV light, the tin plasma is generated by irradiating a laser onto a tin droplet.

However, when the EUV light is generated by using the tin plasma, issues such as formation of contamination due to tin on a lithography mask or a wafer occur.

### SUMMARY

Aspects of the present disclosure and inventive concepts provide a method to prevent tin contamination of a mask and/or a wafer, which may occur in an extreme ultra-violet (EUV) process.

However, the issues to be solved by the inventive concepts are not limited to those described above, and other issues may be clearly understood by those of skill in the art from the following descriptions.

According to some embodiments, an extreme ultra-violet (EUV) light source apparatus includes a chamber body, a reflector, a plurality of gas injection holes, and a plurality of spitting suppression structures. The chamber body has an internal wall and an outer wall. The reflector is under the chamber body and is configured to focus EUV light. The plurality of gas injection holes extend from the outer wall of the chamber body to the internal wall of the chamber body. The plurality of spitting suppression structures are on the internal wall of the chamber body, and are configured to suppress spitting of debris. Each of the plurality of spitting suppression structures includes: a porous structure including a plurality of pores and a plurality of nodes; a plurality of fixing pins fixed to the internal wall of the chamber body, and spaced apart from the porous structure to an outer side of the porous structure; and a plurality of connection members each connected to a respective one of the nodes and a respective one of the fixing pins.

According to some embodiments, an extreme ultra-violet (EUV) light source apparatus includes a chamber body, a gas injection hole, an exhaust port, and a plurality of spitting suppression structures. The chamber body having an internal wall and an outer wall. The gas injection hole extends from the outer wall of the chamber body to the internal wall of the chamber body, and is configured to supply hydrogen gas into the chamber body. The exhaust port is connected to an inside of the chamber body and is configured to exhaust debris to an outside of the chamber body. The exhaust port has an internal wall. The plurality of spitting suppression structures are on the internal wall of the exhaust port, and are configured to suppress spitting of the debris. Each of the plurality of spitting suppression structures includes: a porous structure including a plurality of pores and a plurality of nodes; a plurality of fixing pins fixed to the internal wall of the exhaust port, and spaced apart from the porous structure to an outer side; and a plurality of connection members each connected to a respective one of the nodes and a respective one of the fixing pins.

According to some embodiments, an extreme ultra-violet (EUV) light source apparatus includes a chamber body, a plurality of gas injection holes, an exhaust port, a plurality of first spitting suppression structures, and a plurality of second spitting suppression structures. The chamber body has an internal wall and an outer wall. The plurality of gas injection holes are on a lower region and an upper region of the chamber body to supply a hydrogen gas into the chamber body, and extend from the outer wall of the chamber body to the internal wall of the chamber body. The exhaust port is connected to an inside of the chamber body and is configured to exhaust debris to an outside of the chamber body. The exhaust port has an internal wall. The plurality of first spitting suppression structures are on the internal wall of the chamber body in a debris region. The plurality of second spitting suppression structures are on the internal wall of the exhaust port. The plurality of first spitting suppression structures include a first porous structure, a plurality of first fixing pins fixed to an internal wall of the debris region, and a plurality of first connection members each configured to connect the first porous structure to a respective one of the plurality of first fixing pins. The plurality of second spitting suppression structures comprise a second porous structure, a plurality of second fixing pins fixed to the internal wall of the exhaust port, and a plurality of second connection members configured to connect the second porous structure to a respective one of the plurality of second fixing pins. The debris region is an entire region of the chamber body except for a region where the plurality of gas injection holes are arranged, and a region where the chamber body is connected to the exhaust port.

### BRIEF DESCRIPTION OF THE DRAWINGS

Embodiments will be more clearly understood from the following detailed description taken in conjunction with the accompanying drawings in which:

FIG. 1 is a schematic cross-sectional view of an extreme ultra-violet (EUV) light source apparatus according to some embodiments;

FIG. 2 is a perspective view of a spitting suppression structure according to some embodiments, and is an enlarged view of portion A in FIG. 1;

FIG. 3 is a perspective view of the spitting suppression structure of FIG. 2, and is an enlarged view of portion B in FIG. 2;

FIG. 4 is a cross-sectional view for describing spitting phenomenon of a tin particle;

FIG. 5 is a cross-sectional view for describing a porous structure according to some embodiments;

FIG. 6 is a cross-sectional view of a spitting suppression structure according to some embodiments;

FIG. 7 is a cross-sectional view for describing a vertical direction location of a porous structure, according to some embodiments;

FIG. 8 is a cross-sectional view of a control method of the spitting suppression structure according to some embodiments;

FIGS. 9 and 10 are cross-sectional views illustrating a measuring method of a height of a tin debris layer using a sensor, according to some embodiments;

FIG. 11 is a graph of an effect of the spitting suppression structure, according to some embodiments;

FIG. 12 is a schematic cross-sectional view of the EUV light source apparatus according to some embodiments; and

FIG. 13 is a schematic cross-sectional view of the EUV light source apparatus according to some embodiments.

### DETAILED DESCRIPTION OF THE EMBODIMENTS

Hereinafter, embodiments of the inventive concept will be described in detail with reference to the accompanying drawings. Identical reference numerals are used for the same constituent elements in the drawings, and duplicate descriptions thereof are omitted.

In the inventive concept, a horizontal direction may include a first horizontal direction (X direction) and a second horizontal direction (Y direction), that cross each other. A direction intersecting the first horizontal direction (X direction) and the second horizontal direction (Y direction) may be referred to as a vertical direction (Z direction). In the inventive concept, a vertical level may be referred to as a height level according to the vertical direction (Z direction) of any configuration.

It will be understood that, although the terms “first,” “second,” and/or “third” may be used herein to describe various materials, layers, regions, pads, electrodes, patterns, structure and/or processes, these various materials, layers, regions, pads, electrodes, patterns, structure and/or processes should not be limited by these terms. These terms are only used to distinguish one material, layer, region, pad, electrode, pattern, structure or process from another material, layer, region, pad, electrode, pattern, structure or process. Thus, “first”, “second” and/or “third” may be used selectively or interchangeably in describing each material, layer, region, electrode, pad, pattern, structure or process.

The terms “comprises,” “comprising,” “includes” and/or “including,” when used herein, specify the presence of stated elements, but do not preclude the presence of additional elements. The term “and/or” includes any and all combinations of one or more of the associated listed items.

The term “connected” may be used herein to refer to a physical and/or electrical connection.

A first element described as “on” a second element may be disposed directly on the second element (e.g., in contact with the second element) or indirectly on the second element (e.g., with an intervening element interposed between the first and second elements). When components or layers are referred to herein as “directly” on, or “in direct contact” or “directly connected,” no intervening components or layers are present.

Further, spatially relative terms, such as “under,” “below,” “lower,” “over,” “upper”, etc., may be used herein for ease of description to describe one element or relationship of structures to another element or structure as illustrated in the drawings.

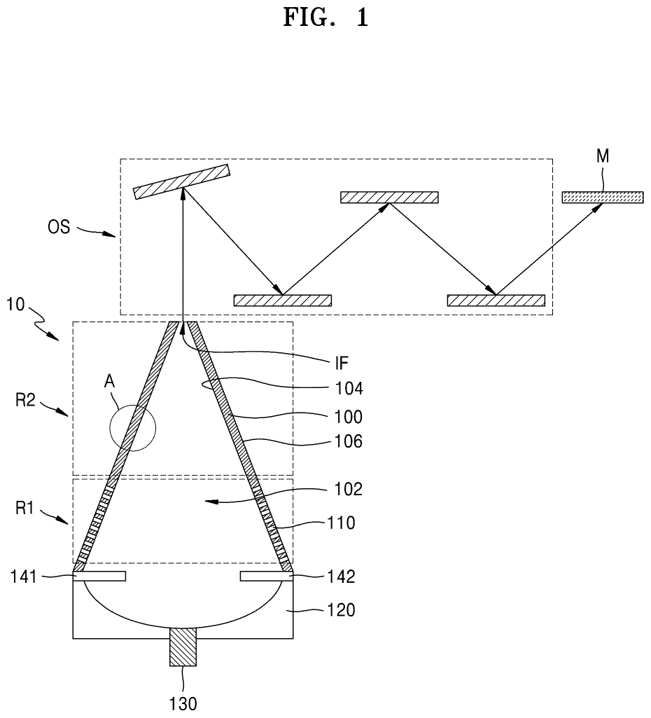

FIG. 1 is a schematic cross-sectional view of an extreme ultra-violet (EUV) light source apparatus 10 according to some embodiments.

Referring to FIG. 1, the EUV light source apparatus 10 may include a chamber body 100, a plurality of gas injection holes 110, a reflector 120, a laser light source 130, a droplet supplier 141, and a catcher 142. The EUV light source apparatus 10 may provide EUV light to an optical system OS, and the optical system OS may transfer the EUV light provided by the EUV light source apparatus 10 to a side of a mask M.

The chamber body 100 may have or define a cavity, chamber or inner space 102 of a certain size, and include a material having good wear resistance and corrosion resistance. The chamber body 100 may also be referred to as a housing, a chamber, etc. As illustrated in FIG. 1, the chamber body 100 may have a truncated conical shape in which a width decreases toward the upper portion. However, the shape of the chamber body 100 is not limited to the truncated conical shape, and may be various shapes, such as a cylindrical shape and a cuboid shape.

A hole for emitting the EUV light to the outside may be formed in an upper end portion of the chamber body 100. An intermediate focusing point IF may be in a hole formed in the upper end portion of the chamber body 100. In this case, the intermediate focusing point IF may mean one point at which the EUV light generated inside the chamber body 100 is focused.

Various types of plasma, such as tin plasma and hydrogen plasma, may be generated inside the chamber body 100. In addition, the inside of the chamber body 100 may be maintained in an ultra-low-pressure state, to prevent the EUV light generated inside the chamber body 100 from being absorbed by the gas present inside the chamber body 100.

A flow path may be formed on an internal wall 104 of the chamber body 100. The flow path formed on the internal wall 104 of the chamber body 100 may include a path through which tin debris flows. For example, the flow path formed on the internal wall 104 of the chamber body 100 may have a spiral shape in which the flow path rotates along the internal wall 104 of the chamber body 100.

The plurality of gas injection holes 110 may include holes extending from an outer wall 106 to the internal wall 104 of the chamber body 100. Each of the plurality of gas injection holes 110 may supply hydrogen gas to the inside 102 of the chamber body 100. The hydrogen gas supplied into the chamber body 100 may chemically remove tin debris or other contaminants.

As illustrated in FIG. 1, the plurality of gas injection holes 110 may be arranged or disposed in a lower portion of the chamber body 100. The plurality of gas injection holes 110 may be arranged at uniform intervals along the circumference of the outer wall 106 of the chamber body 100. Each of the plurality of gas injection holes 110 may include a circular hole having a diameter of several mm. However, each of the plurality of gas injection holes 110 may be implemented in various shapes such as a polygonal shape, may also be arranged on an upper portion of the chamber body 100, and thus, the location and the shape of the plurality of gas injection holes 110 are not limited to the description given above.

The reflector 120 may be arranged or disposed under a lower end of the chamber body 100. The reflector 120 may be connected to a lower end portion of the chamber body 100, and form an integral structure with the chamber body 100. The reflector 120 may include a prolate ellipsoid mirror having a first focus at a point where laser is irradiated onto the tin droplet, or adjacent to the point, and a second focus at the intermediate focusing point IF.

A reflection layer for improving reflectivity of the EUV light may be formed on an upper surface of the reflector 120. The reflection layer may include a plurality of thin layers in which molybdenum (Mo) and silicon (Si) are alternately stacked. In addition, a light source hole in which the laser light source 130 may be arranged may be formed in the reflector 120.

The laser light source 130 may be arranged or disposed in the light source hole formed in the reflector 120 arranged under the chamber body 100. The laser light source 130 may generate the EUV light by irradiating laser onto the tin droplet. The laser light source 130 may include a driver light source, and the laser output by the laser light source 130 may be provided in the form of a pulse wave. The laser may include a pre-pulse laser and a main-pulse laser. The pre-pulse laser may include the laser that is output before the main-pulse laser is irradiated onto the tin droplet. When the pre-pulse laser is irradiated onto the tin droplet, a surface area of the tin droplet may increase. When the surface area of the tin droplet increases, the main-pulse laser may be irradiated onto the tin droplet, and the EUV light may be generated.

The droplet supplier 141 may be arranged under the chamber body 100, and tin droplets for generating the EUV light may be supplied into the chamber body 100. For example, the droplet supplier 141 may be arranged on a lower side surface of the chamber body 100, and supply the tin droplets into the chamber body 100. The tin droplets may be continuously supplied by the droplet supplier 141 at a speed in the range of from about 20 m/s to about 70 m/s and at a time interval of about 20 μs. However, the speed and the time interval at which the droplet supplier 141 supplies the tin droplets may be implemented at various values, and are not limited thereto.

The catcher 142 may be arranged or disposed on a lower side surface of the chamber body 100, and may be arranged on an opposite side of the droplet supplier 141. The catcher 142 may be configured to accommodate the tin droplets discharged by the droplet supplier 141. The catcher 142 may maintain a vacuum pressure less than the barometric pressure inside the chamber body 100 so that the tin droplets inside the chamber body 100 are sucked in. For example, the catcher 142 may maintain a differential pressure that is at least about 0.4 torr lower than the barometric pressure inside the chamber body 100.

As illustrated in FIG. 1, the chamber body 100 may include a first region R1 and a second region R2. The first region R1 of the chamber body 100 may include a region in which the plurality of gas injection holes 110 are arranged or disposed. In addition, the second region R2 may include a region except for the first region R1 among the entire region of the chamber body 100. According to an embodiment, the second region R2 may include a debris region. In this case, the debris region may mean an area in which the tin debris layer is formed on the internal wall 104 of the chamber body 100.

While the inside 102 of the chamber body 100 is maintained at a high temperature, the internal wall 104 of the chamber body 100 may be maintained at a relatively low temperature compared to the temperature inside the chamber body 100. When the tin droplet is irradiated onto the laser emitted by the laser light source 130, the tin plasma may be generated inside the chamber body 100, and the tin plasma may include tin gas, tin ions, and electrons. When tin gas and tin ions collide with the internal wall of the chamber body 100, which is maintained at a relatively low temperature, a phase change into a liquid state may occur. The tin, which has been phase-changed into the liquid state, may be placed on the internal wall 104 of the chamber body 100, and may form the tin debris layer.

Because the first region R1 includes a region in which hydrogen gas is actively introduced through the plurality of gas injection holes 110, the first region R1 may include a region in which tin debris may be actively removed. Accordingly, in the first region R1, the tin debris layer may not be formed, or only a small amount of tin debris may exist.

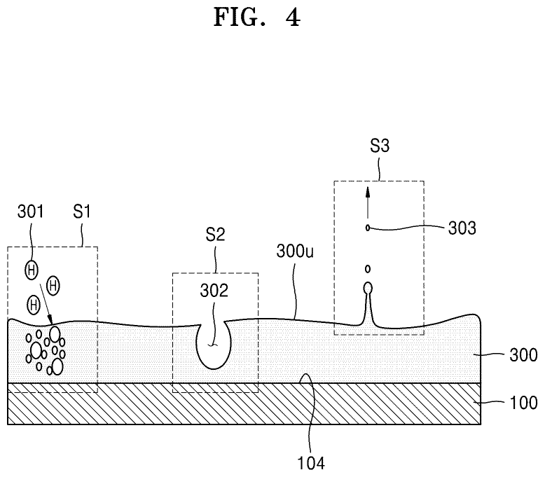

A spitting phenomenon may occur in the debris region. The spitting phenomenon may mean a phenomenon in which tin particles bounce out of the tin debris layer with nonuniform momentum in irregular directions. Due to the spitting phenomenon, contamination in which tin debris adheres to the reflector 120 may occur, and contamination in which tin debris adheres to the optical system OS and/or the mask M may occur. In addition, issues such as contamination due to the tin debris may occur on a wafer. The principle of the spitting phenomenon is described in detail with reference to FIG. 4 to be described below.

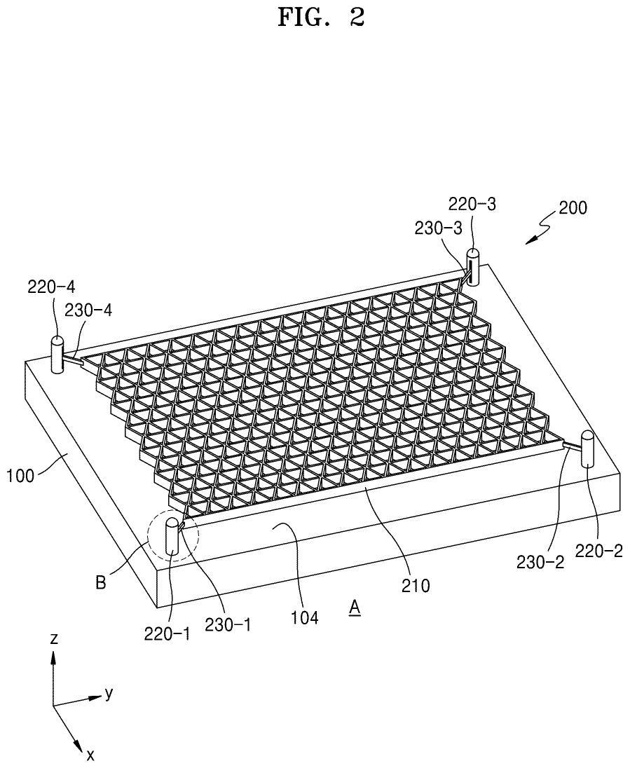

The EUV light source apparatus 10 according to some embodiments may prevent the contamination issue caused by a spitting phenomenon, by including a spitting suppression structure 200 (FIG. 2) arranged on the internal wall 104 of the chamber body 100.

According to the embodiment, the EUV light source apparatus 10 may include a plurality of spitting suppression structures 200 surrounding an internal wall 104 of the second region R2. In this case, each of the plurality of spitting suppression structures 200 may be continuously arranged, and may also surround the entire internal wall 104 of the second region R2.

According to some other embodiments, the EUV light source apparatus 10 may also include a plurality of spitting suppression structures 200 surrounding only a portion of the internal wall 104 of the second region R2. For example, the plurality of spitting suppression structures 200 may be arranged apart from each other at a regular interval. As another example, to suppress the spitting phenomenon in which tin particles bounce out to the outside of the chamber body 100, a plurality of spitting suppression structures 200 may also be intensively arranged on the upper internal wall 104 of the second region R2.

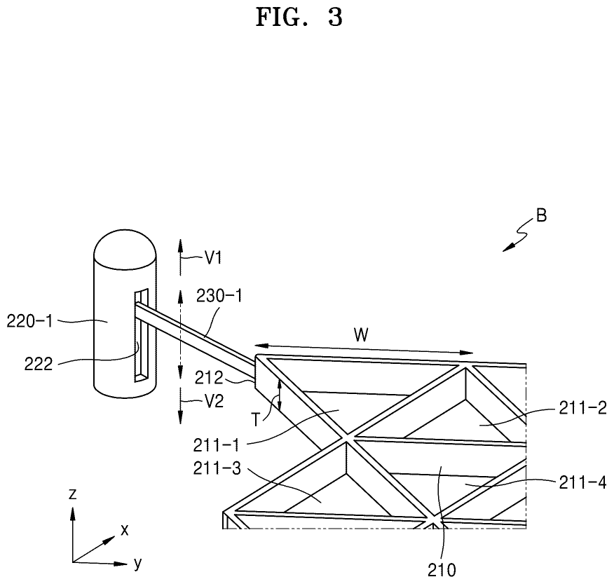

In the description to be given with reference to FIGS. 2 and 3 below, the configuration and structure of the spitting suppression structure 200 capable of suppressing the spitting of tin particles are described in detail.

FIG. 2 is a perspective view of the spitting suppression structure 200 according to some embodiments, and is an enlarged perspective view of portion A in FIG. 1. FIG. 3 is a perspective view of the spitting suppression structure 200 according to an embodiment, and is an enlarged view of portion B in FIG. 2.

Referring to FIGS. 2 and 3, the spitting suppression structure 200 may include a porous structure 210, first through fourth fixing pins 220-1 through 220-4, and first through fourth connection members 230-1 through 230-4.

The porous structure 210 may include a plurality of pores, and in the debris region, may be arranged apart from the inside of the internal wall 104 of the chamber body 100. The porous structure 210 may have a shape corresponding to the internal wall of the chamber body 100.

According to some embodiments, when the chamber body 100 has a truncated conical shape, the porous structure 210 may be implemented as a structure having a curved surface which has the same curvature as a side surface of the truncated cone. According to an embodiment, when the chamber body 100 has a cylindrical shape, the porous structure 210 may be implemented as a structure having a curved surface which has the same curvature as a side surface of a cylinder. The arrangement shape of the porous structure 210 is not limited to the examples described above, and the porous structure 210 may have various arrangements according to the shape of the chamber body 100.

The plurality of pores of the porous structure 210 may be connected to each other, and arranged in parallel with the internal wall 104 of the chamber body 100. In addition, each of the plurality of pores may be arranged in parallel with the internal wall 104 of the chamber body 100. In other words, the distances between each of the plurality of pores included in the porous structure 210 and the internal wall 104 of the chamber body 100 may all be constant. In addition, the plurality of pores may be implemented in various forms.

According to some embodiments, as illustrated in FIG. 3, the plurality of pores may be implemented in an equilateral triangle column shape of the same size, in which the plurality of pores are arranged to be connected to each other. Each of first through fourth pores 211-1 through 211-4 may have a bottom surface of an equilateral triangle shape having a horizontal direction width W, and an equilateral triangle column shape having a vertical direction thickness T. In the inventive concept, “the horizontal direction width of pores” may mean the horizontal direction maximum distance between two points included on a boundary forming one pore. For example, when the bottom surface of the first pore 211-1 has an equilateral triangle shape, the horizontal direction width of the first pore 211-1 may be implemented as a length of one side of the equilateral triangle.

According to some other embodiments, the plurality of pores may be implemented in a square column shape of the same size, in which the plurality of pores are arranged to be connected to each other. In this case, the horizontal direction width of each of the plurality of pores may be implemented as a diagonal length of a square bottom surface. According to some other embodiments, the plurality of pores may be implemented in a circular column shape of the same size, in which the plurality of pores are arranged to be connected to each other. In this case, the horizontal direction width of each of the plurality of pores may be implemented as a diameter length of a circle, that is, the bottom surface of the plurality of pores. The shape of the plurality of pores is not limited to the examples described above, and may be implemented in various shapes, and furthermore, the horizontal direction width of each of the plurality of pores may also be different from each other.

The horizontal direction width W of each of the plurality of pores may be in the range of from about 10 μm to about 10 mm. The horizontal direction width of each of the plurality of pores may be implemented as three times or less of the diameter of a hydrogen bubble formed inside the tin debris layer. In this case, although not clearly revealed, because the diameter of the hydrogen bubble formed inside the tin debris layer is estimated to be several μm to hundreds of μm, implementation of the horizontal direction width W of each of the plurality of pores as from about 10 μm to about 10 mm may be preferred.

Each of first through fourth fixing pins 220-1 through 220-4 may be bonded and fixed to the internal wall 104 of the chamber body 100, and arranged or spaced apart from outer walls of the porous structure 210. For example, as illustrated in FIG. 2, the second fixing pin 220-2 and the third fixing pin 220-3 may be spaced apart from the right side of the porous structure 210, and the first fixing pin 220-1 and the fourth fixing pin 220-4 may be spaced apart from the left side of the porous structure 210. Although FIG. 2 illustrates only the case in which four fixing pins are spaced apart from the outer sides of the porous structure 210, this is only an example, and the number of fixing pins apart from the outer sides of the porous structure 210 may be implemented variously, such as 4 or less or exceeding 4.

According to some embodiments, each of the first through fourth fixing pins 220-1 through 220-4 is in contact with the internal wall 104 of the chamber body 100, and may be fixed to the internal wall thereof by using coupling means for coupling each of the first through fourth fixing pins 220-1 through 220-4 to the internal wall 104 of the chamber body 100. For example, the coupling means may include a bolt and a nut, and the coupling means may also include an adhesive material. However, the coupling means is not limited thereto, and may include various components, such as a clamp and a bracket.

According to some other embodiments, each of the first through fourth fixing pins 220-1 through 220-4 may penetrate from the outer wall 106 of the chamber body 100 to the internal wall 104 of the chamber body 100, and each of the first through fourth fixing pins 220-1 through 220-4 may be fixed to the outer wall sides of the chamber body 100. To fix each of the first through fourth fixing pins 220-1 through 220-4 onto the outer wall of the chamber body 100, the first through fourth fixing pins 220-1 through 220-4 may be fixed by using various methods, such as using a bolt and a nut, and using a clamp and a bracket.

A vertical direction height of each of the first through fourth fixing pins 220-1 through 220-4 may be the same, and may be greater than a vertical direction thickness T of the porous structure 210. For example, the vertical direction height of each of the first through fourth fixing pins 220-1 through 220-4 may be at least ten times the vertical direction thickness T of the porous structure 210. The vertical direction height extends parallel to the z-axis in FIG. 3.

The first through fourth connection members 230-1 through 230-4 may be connected to a plurality of nodes 212 and the first through fourth fixing pins 220-1 through 220-4, respectively. As illustrated in FIG. 3, one end of the first connection member 230-1 may form a coupling with one node 212 arranged or disposed at one corner of the porous structure 210, and the other node the first connection member 230-1 may form a coupling with the first connection member 230-1. By forming the coupling as described above, the first connection member 230-1 may connect between the porous structure 210 and the first fixing pin 220-1.

Each of the first through fourth connection members 230-1 through 230-4 may form one body with or be unitary with the porous structure 210. In other words, when a physical external force is applied to the first through fourth connection members 230-1 through 230-4 or the porous structure 210, the first through fourth connection members 230-1 through 230-4 and the porous structure 210 may operate in one body without a separate movement.

According to some embodiments, when a force is applied in an upper direction V1 (parallel to z-axis) to the first through fourth connection members 230-1 through 230-4, the first through fourth connection members 230-1 through 230-4 and the porous structure 210 may move at the same speed or rate in the upper direction, and for the same distance. According to some other embodiments, when the porous structure 210 moves in the upper direction V1, the first through fourth connection members 230-1 through 230-4 may also move in the same direction as the movement direction of the porous structure 210, and for the same distance as the movement distance of the porous structure 210.

The first through fourth connection members 230-1 through 230-4 may be coupled to the first through fourth fixing pins 220-1 through 220-4 so that the first through fourth connection members 230-1 through 230-4 may move in the vertical direction with respect to the first through fourth fixing pins 220-1 through 220-4, respectively.

According to some embodiments, as illustrated in FIG. 3, the first fixing pin 220-1 may include an accommodation groove 222 having a uniform width in the horizontal direction and extending in the vertical direction. The first connection member 230-1 may be inserted into the accommodation groove, and while the accommodation groove 222 fixes the first connection member 230-1 in the horizontal direction, the accommodation groove 222 may include a guide for allowing the first connection member 230-1 to move in the vertical direction V1.

According to some other embodiments, a guide rail formed after protruding from the outer wall of the first fixing pin 220-1 may also be included. The guide rail may include a coupling member which may be coupled to the first connection member 230-1, and may allow the first connection member 230-1 to move only in the vertical direction. The description given above simply illustrates a form in which the first through fourth connection members 230-1 through 230-4 are coupled to the first through fourth fixing pins 220-1 through 220-4, respectively, and it goes without saying that the first through fourth connection members 230-1 through 230-4 may be respectively coupled to the first through fourth fixing pins 220-1 through 220-4 based on various structures and shapes.

The distance between the porous structure 210 and the internal wall 104 of the chamber body 100 may be adjustable by moving each of the first through fourth connection members 230-1 through 230-4 with respect to the first through fourth fixing pins 220-1 through 220-4, respectively, in the vertical direction V1 or the opposing direction V2.

According to some embodiments, the first through fourth fixing pins 220-1 through 220-4 may be fixed to the internal wall 104 of the chamber body 100, and the first through fourth connection members 230-1 through 230-4 may move about 1 mm in the upper direction with respect to the first through fourth fixing pins 220-1 through 220-4, respectively. In this case, the distance between the porous structure 210 and the internal wall 104 of the chamber body 100 may be about 1 mm. To the contrary, when the first through fourth connection members 230-1 through 230-4 are respectively moved in a downward direction with respect to the first through fourth fixing pins 220-1 through 220-4, the distance between the porous structure 210 and the internal wall 104 of the chamber body 100 may decrease.

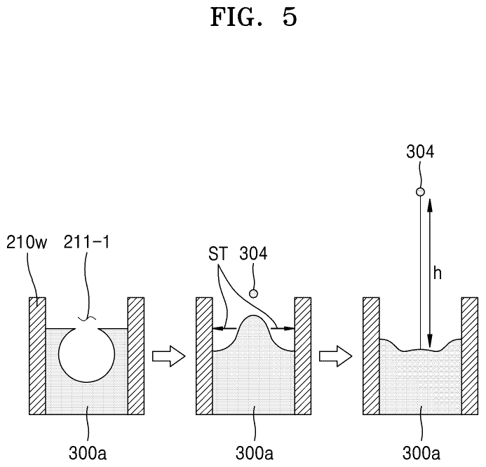

As the porous structure 210 is arranged adjacent to the upper surface of the tin debris layer, the spitting suppression effect may increase. As described above, the spitting suppression structure 200 according to some embodiments may, by adjusting the distance between the porous structure 210 and the internal wall 104 of the chamber body 100 according to a height of the tin debris layer formed on the internal wall 104 of the chamber body 100, arrange the porous structure 210 adjacent to the upper surface of the tin debris layer, and prevent the spitting phenomenon of the tin particle. In the descriptions to be given below with reference to FIGS. 4 and 5, the principle of the spitting phenomenon of the tin particle and the principle of suppressing the spitting phenomenon are described.

FIG. 4 is a cross-sectional view for describing the spitting phenomenon of the tin particle.

Referring to FIG. 4, a tin debris layer 300 that is liquid may be formed on an internal wall 104 of the chamber body 100. In this case, the tin debris layer 300 may be formed in a liquid film shape.

At a first time point S1, a hydrogen radical 301 may permeate the tin debris layer 300. In this case, the hydrogen radical 301 may be generated as the hydrogen gas introduced into the chamber body 100 through the plurality of gas injection holes 110 as illustrated in FIG. 1 is exposed to the high temperature environment inside the chamber body 100.

At a second time point S2, hydrogen radicals 301 having permeated the tin debris layer 300 may be combined with each other to form a hydrogen bubble 302. The hydrogen bubble 302 may be formed at a position adjacent to an upper surface 300u of the tin debris layer 300.

At a third time point S3, the hydrogen bubble 302 may rupture on the upper surface of the tin debris layer 300, and a tin particle 303 may be spit by the rupture of the hydrogen bubble 302. In other words, the spitting phenomenon of the tin particle 303 may occur based on the rapid vibration of the surface of the tin debris layer 300, caused by the rupture of the hydrogen bubble 302.

The rapid vibration of the surface of the tin debris layer 300 as described above may be suppressed by the spitting suppression structure 200, according to an embodiment. In the description to be provided below with reference to FIG. 5, the effect of the porous structure 210 of the spitting suppression structure 200 is described in detail.

FIG. 5 is a cross-sectional view for describing the effect of the porous structure 210 according to some embodiments.

Referring to FIG. 5, a first tin debris 300a in a liquid state may be arranged inside the first pore 211-1 included in the porous structure 210. In this case, the first pore 211-1 may include one pore surrounded by a first pore wall 210w among the plurality of pores included in the porous structure 210. In addition, the first tin debris 300a may be included in the tin debris layer 300 formed on the internal wall 104 of the chamber body 100, and may include the tin debris inside the first pore 211-1.

An upper surface of the first pore wall 210w may be higher than an upper surface of the first tin debris 300a. In addition, although not illustrated in detail in FIG. 5, a lower surface of the first pore wall 210w may be inside the tin debris layer 300. In other words, the lower surface of the porous structure 210 may be above a lower surface of the tin debris layer 300.

The hydrogen bubble may also be formed due to permeation of the hydrogen radical, inside the first tin debris 300a arranged inside the first pore 211-1. However, a surface tension ST may act between the first pore wall 210w and the first tin debris 300a, and a damping effect based on the surface tension ST may occur. In other words, the surface tension ST may occur in which the first pore wall 210w pulls the first tin debris 300a in the direction of the first pore wall 210w, and the surface tension ST as described above may suppress the occurrence of rapid vibration on the surface of the first tin debris 300a.

Due to the influence of the surface tension ST as described above, the number of tin particles 304, which are spit, may decrease. For example, when the porous structure 210 is arranged, the number of tin particles 304, which are spit, may be about 20% to about 80% of the number of tin particles, which are spit in a state where the porous structure 210 is not arranged.

In addition, although the tin particles 304 are spit due to the influence of surface tension ST, the momentum of the tin particles 304, which are spit, may not be large. Assuming that the tin particles 304, which are spit, move only in the vertical direction, a height “h” may be the maximum height, and may be relatively less than the maximum height of the tin particles 303 illustrated in FIG. 4. For example, the maximum height of the tin particles 304, which are spit, may be reduced by about 20% to about 80%.

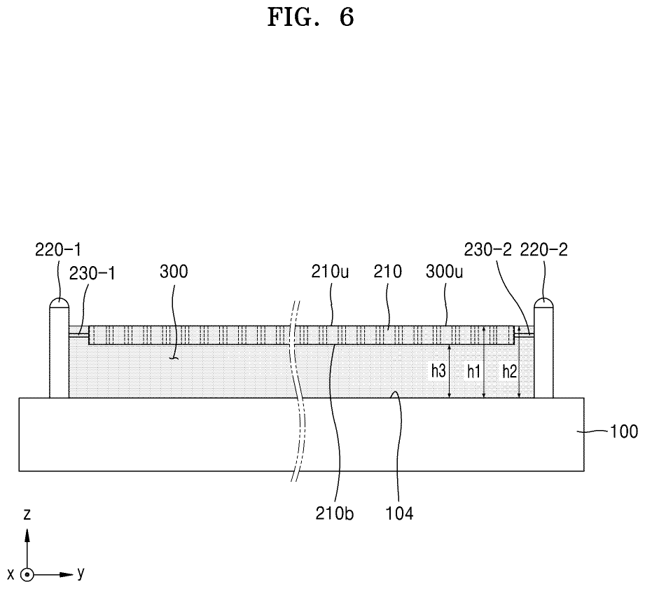

As described above, when the porous structure 210 including the plurality of pores is arranged adjacent to the upper surface of the tin debris layer 300, the spitting phenomenon of the tin particles 304 may be prevented and the movement amount of the tin particles 304, which are spit, may also decrease. Accordingly, a phenomenon of tin contamination may be prevented from occurring in the optical system OS, the mask M, and/or a wafer. In the description to be described below with reference to FIGS. 6 through 10, detailed methods of arranging the porous structure 210 adjacent to the upper surface of the tin debris layer 300 are described in detail.

FIG. 6 is a cross-sectional view of the spitting suppression structure 200 according to an embodiment.

Referring to FIG. 6, the tin debris layer 300 may be formed on the internal wall 104 of the chamber body 100, and the porous structure 210 may be arranged or spaced apart inwardly from the internal wall of the chamber body 100 and be adjacent to the upper surface of the tin debris layer 300.

In the description with reference to FIG. 6, for convenience of description, it is assumed that the distance between the upper surface 300u of the tin debris layer 300 and the internal wall 104 of the chamber body 100 is “h2”, the distance between the upper surface 210u of the porous structure 210 and the internal wall of the chamber body 100 is “h1”, and the distance between the lower surface of the porous structure 210 and the internal wall 104 of the chamber body 100 is “h3”.

According to some embodiments, the lower surface 210b of the porous structure 210 may be arranged or disposed below the upper surface 300u of the tin debris layer 300, and the upper surface 210u of the porous structure 210 may be arranged at the same vertical level as the upper surface 300u of the tin debris layer 300. In other words, h1 may be the same as h2, and h3 may be less than h2. By using the arrangement of the porous structure 210 as described above, the tin debris on the upper surface of the tin debris layer 300 or adjacent to the upper surface thereof may be arranged inside the plurality of pores of the porous structure 210.

When the upper surface 300u of the tin debris layer 300 and the upper surface 210u of the porous structure 210 are arranged at the same vertical level, as described above, that is, when h1 is the same as h2, a contact area between the tin debris and a pore wall included in the porous structure 210 may be the maximum. Accordingly, the interaction between the tin debris and the pore wall may be strengthened, and the stability of the tin debris in a liquid state may increase. Thus, the rapid vibration occurring on the upper surface of the tin debris layer 300 may be suppressed, and the spitting phenomenon of the tin particle may be significantly alleviated.

When the upper surface 210u of the porous structure 210 is arranged at a vertical level lower than the upper surface 300u of the tin debris layer 300, that is, when h1 is less than h2, the tin debris on the upper surface of the tin debris layer 300 or adjacent to the upper surface of the tin debris layer 300 may not be arranged inside the plurality of pores of the porous structure 210, and therefore, the spitting suppression effect due to the surface tension as described above with reference to FIG. 5 may not be properly exhibited.

FIG. 6 illustrates only two fixing pins (220-1 and 220-2) and two connection members (230-1 and 230-2), but this is only for convenience of explanation, and the porous structure 210 may also be fixed by two or more fixing pins and two or more connection members.

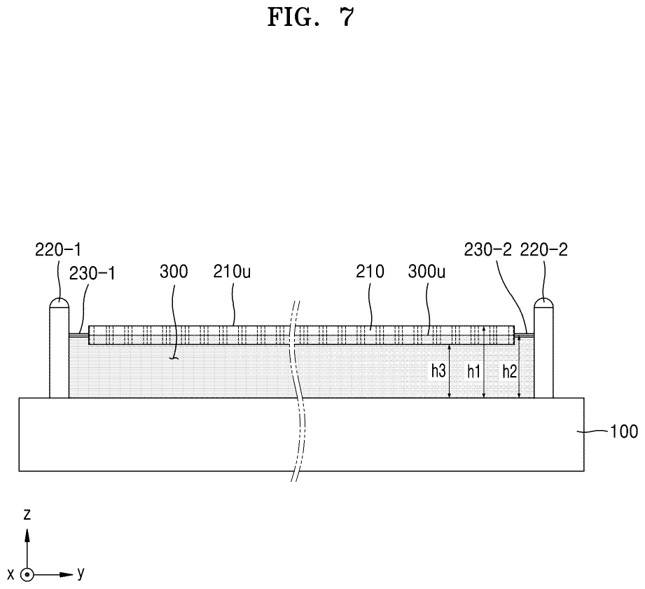

FIG. 7 is a cross-sectional view for describing a vertical direction position of the porous structure 210, according to some embodiments.

As illustrated in FIG. 7, the upper surface 210u of the porous structure 210 may be arranged at a vertical level higher than the upper surface 300u of the tin debris layer 300, and the lower surface of the porous structure 210 may be arranged at a vertical level lower than the upper surface of the tin debris layer 300. In other words, h1 may be greater than h2, and h3 may be less than h2.

As described above with respect to FIG. 6, it may be most desirable to arrange the upper surface of the porous structure 210 at the same vertical level as the upper surface of the tin debris layer 300. However, it may be difficult to arrange the upper surface of the porous structure 210 at the same vertical level as the upper surface of the tin debris layer 300 according to the height of the tin debris layer 300 that changes finely depending on the progress of the process. Accordingly, the upper surface of the porous structure 210 may be arranged at a vertical level higher than the upper surface of the tin debris layer 300, but the lower surface of the porous structure 210 may be arranged at a vertical level lower than the upper surface of the tin debris layer 300.

According to some embodiments, the porous structure 210 may include a metal having a density less than that of tin. Because the porous structure 210 includes a metal having a density less than that of tin, the upper surface of the porous structure 210 may be arranged at a vertical level higher than the upper surface 300u of the tin debris layer 300 due to buoyancy. For example, the porous structure 210 may include a metal, such as aluminum and titanium. In this case, the upper surface 210u of the porous structure 210 may be arranged at a higher vertical level than that of the tin debris layer 300, and the lower surface of the porous structure 210 may be arranged at a lower vertical level than that of the tin debris layer 300.

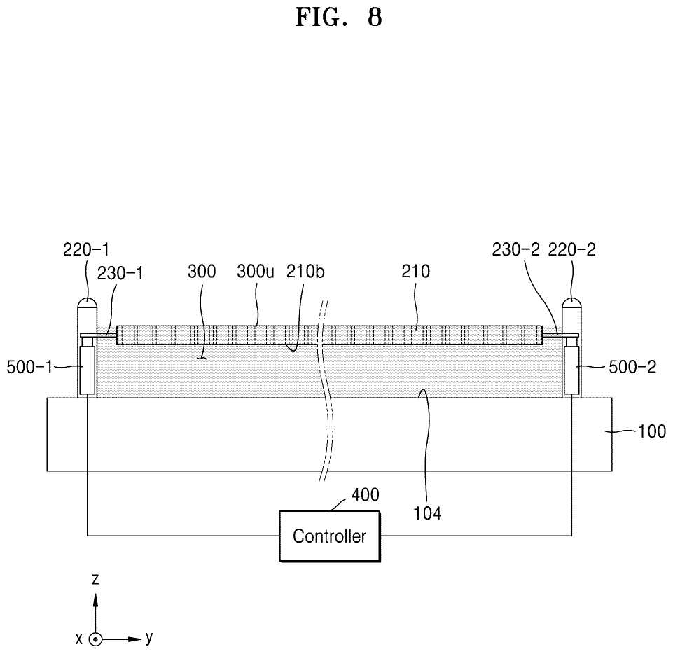

FIG. 8 is a cross-sectional view for explaining a control method of the spitting suppression structure 200, according to some embodiments.

Referring to FIG. 8, the EUV light source apparatus 10 according to some embodiments may include a controller 400 and first and second actuators 500-1 and 500-2.

The first actuator 500-1 and the second actuator 500-2 may be coupled to the first fixing pin 220-1 and the second fixing pin 220-2, respectively. For example, as illustrated in FIG. 8, the first actuator 500-1 and the second actuator 500-2 may be disposed inside the first fixing pin 220-1 and the second fixing pin 220-2, respectively.

The controller 400 may be operatively connected to the first actuator 500-1 and the second actuator 500-2. In addition, although not illustrated in FIG. 8, the controller 400 may obtain information about the height of the tin debris layer 300 from a sensor measuring the height of the tin debris layer 300, and the controller 400 may be connected to a memory unit. The controller 400 may include at least one of a microprocessor, a digital signal processor, or a processing device similar thereto.

The first actuator 500-1 and the second actuator 500-2 may move the first connection member 230-1 and the second connection member 230-2 in the vertical direction (i.e., parallel to z-axis) with respect to each of the first fixing pin 220-1 and the second fixing pin 220-2, respectively. As an example, the first actuator 500-1 and the second actuator 500-2 may be implemented as linear actuators. However, it goes without saying that each of the first actuator 500-1 and the second actuator 500-2 is not limited to a linear actuator, and may be implemented as various linear driving devices capable of moving each of the first connection member 230-1 and the second connection member 230-2 in the vertical direction.

According to some embodiments, the controller 400 may control the first actuator 500-1 and the second actuator 500-2 such that the lower surface 210b of the porous structure 210 is arranged below the upper surface 300u of the tin debris layer 300. When the height of the upper surface of the tin debris layer 300 is about 5 mm, the controller 400 may control the first actuator 500-1 and the second actuator 500-2 such that the height of the lower surface of the porous structure 210 is less than about 5 mm.

According to some other embodiments, the controller 400 may control the first actuator 500-1 and the second actuator 500-2 such that a first distance between the upper surface 210u of the porous structure 210 and the internal wall 104 of the chamber body 100 is greater than or equal to a second distance. In this case, the second distance may be a distance between the upper surface of the tin debris layer 300 and the internal wall 104 of the chamber body 100.

According to some other embodiments, the EUV light source apparatus 10 may further include the memory unit. The memory unit may include at least one type of storage medium among a flash memory type memory, a hard disk type memory, a multimedia card micro type memory, a card type memory (for example, secure digital (SD) or extreme digital (XD) memory), random access memory (RAM), static RAM (SRAM), random access memory (ROM), electrically erasable programmable ROM (EPROM), programmable ROM (PROM), magnetic memory, a magnetic disk, and an optical disk.

The memory unit may store height information of the tin debris layer 300. In this case, the height information of the tin debris layer 300 may include information about the height of the tin debris layer 300 that changes over time. In other words, the memory unit may store information about how the height of the tin debris layer 300 changes in each region of the chamber body 100. For example, the height information of the tin debris layer 300 may include data that is obtained after measuring the height of the tin debris layer 300 that changes according to the number of time points at which the laser light source 130 outputs laser, and storing the measured height of the tin debris layer 300 for each area of the chamber body 100.

According to some embodiments, the controller 400 may control the first actuator 500-1 and the second actuator 500-2 such that the distance between the porous structure 210 and the internal wall 104 of the chamber body 100 is changed, based on the height information of the tin debris layer 300. For example, the height information of the tin debris layer 300 may include data indicating that at every 1,000 times the laser light source 130 outputs laser, the height of the tin debris layer 300 formed on an internal wall 104 of portion A in FIG. 1 increases by about 1 mm. Accordingly, whenever the laser light source 130 outputs the laser 1,000 times, the controller 400 may control the first actuator 500-1 and the second actuator 500-2 so that the distance between the porous structure 210 and the internal wall of the chamber body 100 increases about 1 mm.

The description provided above only illustrates one control operation in which the controller 400 controls the first actuator 500-1 and the second actuator 500-2, and it goes without saying that the controller 400 may control the first actuator 500-1 and the second actuator 500-2 based on various methods.

FIG. 8 illustrates only that the first connection member 230-1 and the second connection member 230-2 may be inserted into the first fixing pin 220-1 and the second fixing pin 220-2 to be coupled to the first actuator 500-1 and the second actuator 500-2, respectively, but this is only an example. It goes without saying that the first connection member 230-1 and the second connection member 230-2 may be coupled to the outer surfaces of the first fixing pin 220-1 and the second fixing pin 220-2, respectively, and that the first connection member 230-1 and the second connection member 230-2 may be coupled to the first actuator 500-1 and the second actuator 500-2 based on various coupling forms, respectively.

Although FIG. 8 illustrates only one controller 400 connected to one spitting suppression structure 200, this is only for convenience of explanation, and it goes without saying that the controller 400 included in the EUV light source apparatus 10 may control each of the plurality of actuators included in each of the plurality of spitting suppression structures 200 respectively arranged on the internal wall 104 of the chamber body 100.

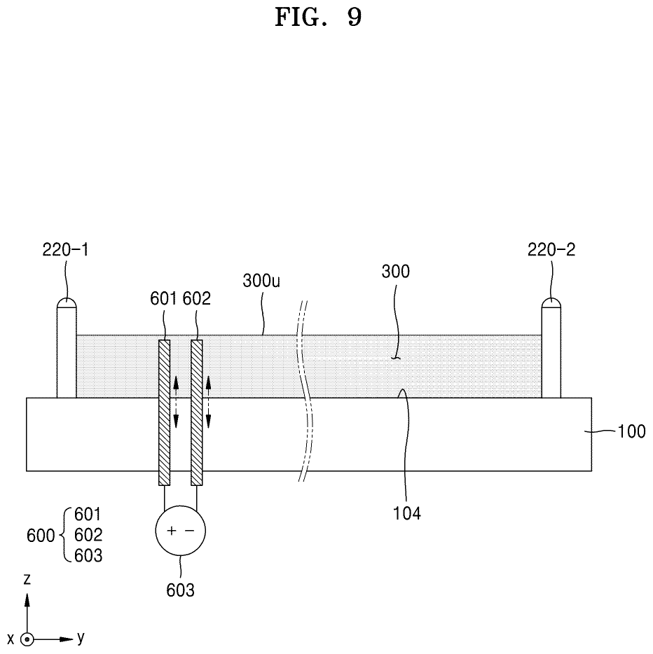

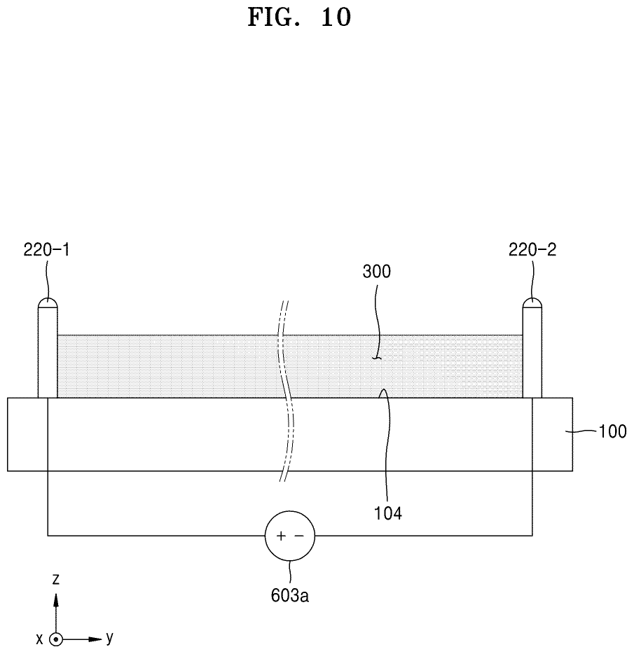

FIGS. 9 and 10 are cross-sectional views for describing a measurement method of the height of the tin debris layer of a sensor 600 according to embodiments.

Referring to FIG. 9, the sensor 600 may include a first electrode 601, a second electrode 602, and a power source 603. The sensor 600 may sense electrical conductivity of a material arranged between the first electrode 601 and the second electrode 602, and identify the height of the tin debris layer 300 based on the sensed electrical conductivity value.

The power source 603 may apply a voltage to each of the first electrode 601 and the second electrode 602. According to some embodiments, the power source 603 may include a direct current power source that applies a positive potential and a negative potential to each of the first electrode 601 and the second electrode 602. According to some other embodiments, the power source 603 may also include an alternating current power source that applies a positive potential and a negative potential to each of the first electrode 601 and the second electrode 602.

Each of the first electrode 601 and the second electrode 602 may penetrate the internal wall 104 of the chamber body 100 from the outer wall 106 of the chamber body 100 and may be inserted into the tin debris layer 300. In addition, the first electrode 601 and the second electrode 602 may be arranged to move in up/down directions. For example, the first electrode 601 and the second electrode 602 may be connected to the driving device, and the driving device may move the first electrode 601 and the second electrode 602 in units of several nm to several hundreds of nm in up/down directions.

The positive potential and the negative potential may be applied to each of the first electrode 601 and the second electrode 602, and the first electrode 601 and the second electrode 602 may be at the vertical level lower than the upper surface 300u of the tin debris layer 300. Because the tin debris layer 300 includes a conductive liquid layer, the electrical conductivity value measured by the sensor 600 may be high.

On the other hand, when the first electrode 601 and the second electrode 602 are moved in the upper direction to be exposed to the outside of the tin debris layer 300, the electrical conductivity value measured by the sensor 600 may be reduced. The hydrogen gas that is electrically neutral may be present outside the tin debris layer 300. In other words, while the electrical conductivity of the tin debris layer 300 is high, the electrical conductivity of the gas present outside the tin debris layer 300 may be relatively low.

According to an embodiment, the sensor 600 may move the first electrode 601 and the second electrode 602 in the upper direction by using the driving device, and may identify the vertical direction positions of the first electrode 601 and the second electrode 602 at a point where the sensed electrical conductivity rapidly decreases. In addition, the sensor 600 may identify the identified vertical direction positions of the first electrode 601 and second electrode 602 as the height of the tin debris layer 300 formed on the internal wall 104 of the chamber body 100.

According to some other embodiments, the sensor 600 may move the first electrode 601 and the second electrode 602 in the downward direction by using the driving device, and may identify the vertical direction positions of the first electrode 601 and the second electrode 602 at a point where the sensed electrical conductivity rapidly increases. In addition, the sensor 600 may identify the identified vertical direction positions of the first electrode 601 and second electrode 602 as the height of the tin debris layer 300 formed on the internal wall 104 of the chamber body 100.

Referring to FIG. 10, the sensor 600 may include the first fixing pin 220-1 and the second fixing pin 220-2. In other words, the functions of the first electrode 601 and the second electrode 602 illustrated in FIG. 9 may be performed by any two fixing pins (for example, the first fixing pin 220-1 and the second fixing pin 220-2) arranged adjacent to each other, among a plurality of fixing pins fixed to the internal wall of the chamber body 100.

In this case, the first fixing pin 220-1 and the second fixing pin 220-2 may include conductive materials. For example, the first fixing pin 220-1 and the second fixing pin 220-2 may include a metal material, such as copper, aluminum, nickel, titanium, and molybdenum.

A power source 603a may apply the positive potential and the negative potential to each of the first fixing pin 220-1 and the second fixing pin 220-2. The sensor 600 may sense the electrical conductivity of a material arranged between the first fixing pin 220-1 and the second fixing pin 220-2, and may identify the height of the tin debris layer 300 based on the sensed electrical conductivity value.

When the height of the tin debris layer 300 increases, the electrical conductivity value sensed by the sensor 600 may increase. To the contrary, when the height of the tin debris layer 300 decreases, the electrical conductivity value sensed by the sensor 600 may decrease. The reason may be that the tin debris layer 300 is a conductive liquid, whereas an electrically neutral gas exists outside the tin debris layer 300. Based on this principle, the sensor 600 may identify the height of the tin debris layer 300.

The sensor 600 may identify the height of the tin debris layer 300 as about 3 mm when the measured electrical conductivity value is about 3*10⁵ S/m, and the height of the tin debris layer 300 as about 3.50 mm when the electrical conductivity value is 4*10⁵ S/m. However, the values described above are only values presented for convenience of explanation, and sensing values of the sensor 600 according to some embodiments are not limited thereto.

Referring to FIG. 8 again, the controller 400 may obtain a sensing value of the height of the tin debris layer 300 from the sensor 600, and may control the first actuator 500-1 and the second actuator 500-2 so that the distance between the porous structure 210 and the internal wall 104 of the chamber body 100 is changed, based on the sensing value of the height of the tin debris layer 300.

For example, the controller 400 may identify that the height of the tin debris layer 300 is about 3 mm from the sensor 600, and control the first actuator 500-1 and the second actuator 500-2 so that the distance between the upper surface of the porous structure 210 and the internal wall 104 of the chamber body 100 becomes about 3 mm.

In FIGS. 9 and 10, only the sensor 600 that measures the height of the tin debris layer 300 based on the electrical conductivity value is illustrated, but this is only an example, and it goes without saying that the height of the tin debris layer 300 may also be identified by using an optical sensor, an ultrasonic sensor, etc.

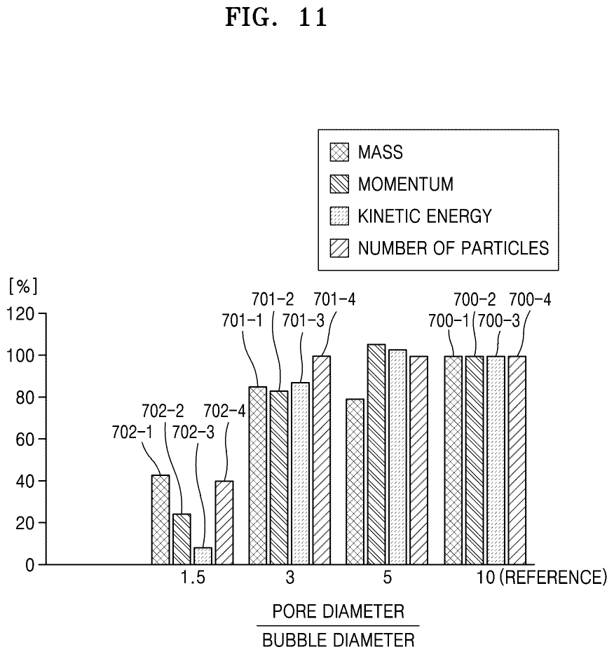

FIG. 11 is a graph of an effect of the spitting suppression structure 200, according to an embodiment.

FIG. 11 is a graph illustrating simulation results confirming the spitting suppression effect of the tin particle, by changing a ratio of a diameter of the pore included in the porous structure 210 to the diameter of the hydrogen bubble generated by the hydrogen radical permeation.

According to the graph illustrated in FIG. 11, when the ratios of the diameter of hydrogen bubbles to the diameter of the pores are about 3 and about 1.5, it may be confirmed that the spitting suppression effect occurs. In this case, the simulation result of the case when the ratio of the diameter of the hydrogen bubbles to the diameter of the pores is about 10 may be set as a reference value. The values represented by a reference mass bar graph 700-1, a reference momentum bar graph 700-2, a reference kinetic energy bar graph 700-3, and a reference particle number bar graph 700-4 may be set as 100%, and the amount of change in a mass, momentum, kinetic energy, and the particle number of the tin particle spit by changing the ratio of the diameter of the hydrogen bubble to the diameter of the pore may be identified.

When the ratio of the diameter of the hydrogen bubble to the diameter of the pore is about 3, the simulation result may refer to a first mass bar graph 701-1, a first movement amount bar graph 701-2, a first momentum bar graph 701-3, and a first particle number bar graph 701-4. When compared to the case where the ratio of the diameter of the hydrogen bubble to the diameter of the pore is about 10, it may be verified that the mass, the momentum, and kinetic energy of the spit tin particle has been reduced to about 80%. It may be verified that the number of spit tin particles has not been reduced.

When the ratio of the diameter of the hydrogen bubble to the diameter of the pore is about 1.5, the simulation result may refer to a second mass bar graph 702-1, a second momentum bar graph 702-2, a second movement energy bar graph 702-3, and a second particle number bar graph 702-4. When the ratio of the diameter of the hydrogen bubble to the diameter of the pore is about 10, it may be verified that the mass of the spit tin particle is reduced by about 40%, the momentum is reduced by about 20%, and the number of spit tin particles is reduced by about 40%.

On the other hand, referring to the bar graph for the case when the ratio of the diameter of hydrogen bubble to the diameter of the pore is about 5, it can be verified that the spitting suppression effect of the tin particle has not been significant.

The diameter of the hydrogen bubble generated by permeation of the hydrogen radical into the tin debris layer 300 has not been clearly revealed, but it may be estimated to be several μm to several hundred μm. In addition, according to the simulation result illustrated in FIG. 11, it may be desirable that the diameters of the plurality of pores included in the porous structure 210 are implemented three times or less the diameters of the hydrogen bubbles. Accordingly, the diameter of each of the plurality of pores included in the porous structure 210 may be preferably implemented in a range of from about 10 μm to about 10 mm.

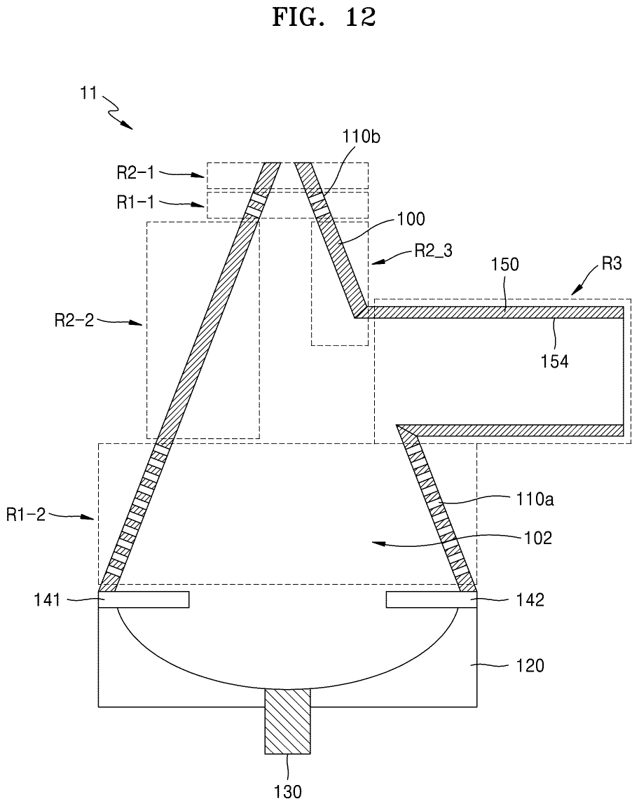

FIG. 12 is a schematic cross-sectional view of an EUV light source apparatus 11 according to an embodiment.

In the description with reference to FIG. 12, the same portion as the description with reference to FIG. 1 is omitted, and the differences from the EUV light source apparatus 10 illustrated in FIG. 1 are mainly described.

The EUV light source apparatus 11 may further include a plurality of lower gas injection holes 110a arranged under the chamber body 100 and a plurality of upper gas injection holes 110b arranged on the chamber body 100. In this case, a region in which the plurality of upper gas injection holes 110b are arranged may include a 1-1 region R1-1, and a region in which a plurality of lower gas injection holes 110a are arranged may include a 1-2 region R1-2. The hydrogen gas may be supplied via the plurality of upper gas injection holes 110b and the plurality of lower gas injection holes 110a.

The EUV light source apparatus 11 may further include an exhaust port 150 connected to the inside 102 of the chamber body 100 and located above the plurality of lower gas injection holes 110a. The exhaust port 150 may discharge debris, such as tin plasma and hydrogen gas, from the inside of the chamber body 100 to the outside of the chamber body 100. Although not illustrated in FIG. 11, the exhaust port 150 may be connected to a scrubber, a tin debris tank, or the like to discharge debris inside the chamber body 100 to the outside of the chamber body 100.

In this case, the tin debris layer may also be formed on the internal wall 154 of the exhaust port 150, and the spitting phenomenon of the tin particle may occur. Accordingly, the plurality of spitting suppression structures 200, the controller 400, a plurality of actuators, the sensor 600, or the like described with reference to FIGS. 2 through 10 may also be arranged on the internal wall 154 of the exhaust port 150. Because on the internal wall 154 of the exhaust port 150, the plurality of spitting suppression structures 200, the controller 400, the plurality of actuators, the sensor 600, or the like may be arranged in the same/similar manner as described with reference to FIGS. 2 through 10, a detailed description thereof is substantially the same as the description given with reference to FIGS. 2 through 11, and accordingly, is omitted.

According to some embodiments, the debris region may include, among the entire region of the chamber body 100, a region except for a region in which the plurality of lower gas injection holes 110a and the plurality of upper gas injection holes 110b are arranged, and a region to which the exhaust port 150 is connected. As illustrated in FIG. 11, the debris region may include a 2-1 region R2-1, a 2-2 region R2-2, and a 2-3 region R2-3. Because the plurality of spitting suppression structures 200 are arranged in the debris region, the plurality of spitting suppression structures 200 may be arranged, on the internal wall 104 of the chamber body 100, in the 2-1 region R2-1, the 2-2 region R2-2, and the 2-3 region R2-3. In addition, the plurality of spitting suppression structures 200 may also be arranged on the internal wall 154 of the exhaust port 150 in a third region R-3.

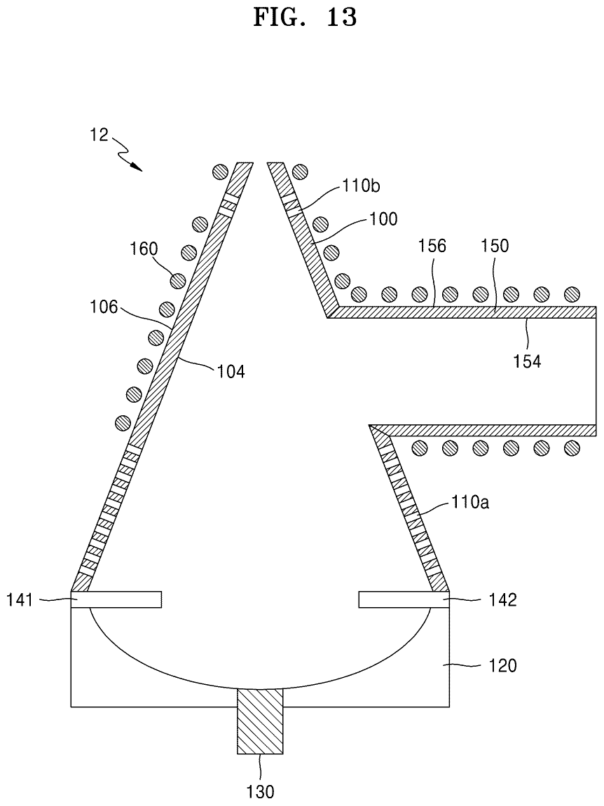

FIG. 13 is a schematic cross-sectional view of an EUV light source apparatus 12 according to some embodiments.

Duplicate descriptions given with reference to FIGS. 1 and 11 for FIG. 12 are omitted, and differences between the EUV light source 10 illustrated in FIG. 1 and the EUV light source 11 illustrated in FIG. 11 are mainly described.

Referring to FIG. 13, the EUV light source apparatus 12 may further include a heater 160.

According to the embodiments, the heater 160 may be arranged on the outer wall 106 of the chamber body 100 in the debris region. The heater 160 may be arranged along the outer wall 106 of the chamber body 100 to surround the outer wall 106 of the chamber body 100. The heater 160 may heat the tin debris layer formed on the internal wall 104 of the chamber body 100 up to a melting point of the tin or higher. In this case, the melting point of tin may be about 232° C. However, the melting point of tin may vary depending on the pressure condition inside the chamber body 100. The heater 160 may prevent the tin debris layer from coagulating.

According to some other embodiments, the heater 160 may be arranged on the outer wall 156 of the exhaust port 150, and may also heat the tin debris layer formed on the internal wall 154 of the exhaust port 150 above the melting point. The heater 160 may be arranged along the outer wall 156 of the exhaust port 150 to surround the outer wall of the exhaust port 150.

The EUV light source apparatus according to some embodiments may include the configuration as described above, and thus, prevent tin contamination on an optical system, a mask, and/or a wafer due to the spitting phenomenon of tin particles.

While the inventive concept has been particularly shown and described with reference to embodiments thereof, it will be understood that various change in form and details may be made therein without departing from the spirit and scope of the following claims.

What is claimed is:

1. An extreme ultra-violet (EUV) light source apparatus comprising:
a chamber body having an internal wall and an outer wall;
a reflector under the chamber body and configured to focus EUV light;
a plurality of gas injection holes extending from the outer wall of the chamber body to the internal wall of the chamber body; and
a plurality of spitting suppression structures on the internal wall of the chamber body, and configured to suppress spitting of debris,
wherein each of the plurality of spitting suppression structures includes:
a porous structure including a plurality of pores and a plurality of nodes;
a plurality of fixing pins fixed to the internal wall of the chamber body, and spaced apart from the porous structure to an outer side of the porous structure; and
a plurality of connection members each connected to a respective one of the nodes and a respective one of the fixing pins.

2. The EUV light source apparatus of claim 1,
wherein each of the plurality of spitting suppression structures is located on the internal wall of the chamber body in a debris region, and
wherein the debris region is an entire region of the chamber body except for a region where the plurality of gas injection holes are located.

3. The EUV light source apparatus of claim 2,
wherein, in the debris region, the porous structure has a shape corresponding to the internal wall of the chamber body, and is spaced apart from the internal wall of the chamber body toward an inner side of the chamber body, and
wherein the plurality of pores are connected to each other, and arranged in parallel with the internal wall of the chamber body.

4. The EUV light source apparatus of claim 2,
wherein the plurality of connection members are coupled to the plurality of fixing pins so that the plurality of connection members are movable with respect to the plurality of fixing pins in a vertical direction, respectively, and
wherein a distance between the porous structure and the internal wall of the chamber body is adjustable by moving each of the plurality of connection members in a vertical direction with respect to each of the plurality of fixing pins.

5. The is EUV light source apparatus of claim 4, further including:
an actuator coupled to each of the plurality of fixing pins, and configured to move each of the plurality of connection members with respect to each of the plurality of fixing pins in the vertical direction; and
a controller configured to control the actuator,
wherein the controller controls the actuator so that a lower surface of the porous structure is positioned under an upper surface of a tin debris layer formed on the internal wall of the chamber body.

6. The EUV light source apparatus of claim 5,
wherein the controller controls the actuator so that a first distance between an upper surface of the porous structure and the internal wall of the chamber body is greater than a second distance, and
wherein the second distance is a distance between the upper surface of the tin debris layer and the internal wall of the chamber body.

7. The EUV light source apparatus of claim 5, further including a memory unit configured to store height information of the tin debris layer,
wherein the controller, based on the height information of the tin debris layer, controls the actuator so that a distance between the porous structure and the internal wall of the chamber body is changed, and
wherein the height information of the tin debris layer includes information about a change over time of a height of the tin debris layer.

8. The EUV light source apparatus of claim 5, further including a sensor configured to measure a height of the tin debris layer,
wherein the controller:
obtains a sensing value of the height of the tin debris layer from the sensor, and
based on a sensing value of the height of the tin debris layer, controls the actuator to change the distance between the porous structure and the internal wall of the chamber body.

9. The EUV light source apparatus of claim 1,
wherein the porous structure comprises a metal having a lower density than tin, and
a horizontal direction width of each of the plurality of pores is in a range of from about 10 [symbol] to about 10 [symbol] .

10. The EUV light source apparatus of claim 1,
further comprising a heater configured to heat a tin debris layer formed on the internal wall of the chamber body to a melting point of tin or higher, and arranged on the outer wall of the chamber body.

11. An extreme ultra-violet (EUV) light source apparatus comprising:
a chamber body having an internal wall and an outer wall;
a gas injection hole extending from the outer wall of the chamber body to the internal wall of the chamber body, and configured to supply hydrogen gas into the chamber body;
an exhaust port connected to an inside of the chamber body and configured to exhaust debris to an outside of the chamber body, the exhaust port having an internal wall; and
a plurality of spitting suppression structures on the internal wall of the exhaust port, and configured to suppress spitting of the debris,
wherein each of the plurality of spitting suppression structures includes:
a porous structure including a plurality of pores and a plurality of nodes;
a plurality of fixing pins fixed to the internal wall of the exhaust port, and spaced apart from the porous structure to an outer side; and
a plurality of connection members each connected to a respective one of the nodes and a respective one of the fixing pins.

12. The EUV light source apparatus of claim 11,
wherein the porous structure has a shape corresponding to the internal wall of the exhaust port, and spaced apart from the internal wall of the exhaust port to an inner side, and
wherein the plurality of pores are connected to each other, and arranged in parallel with the internal wall of the exhaust port.

13. The EUV light source apparatus of claim 11,
wherein the plurality of connection members are coupled to the plurality of fixing pins so that the plurality of connection members may move with respect to the plurality of fixing pins in a vertical direction, respectively, and
wherein a distance between the porous structure and the internal wall of the exhaust port is adjustable by moving each of the plurality of connection members in a vertical direction with respect to each of the plurality of fixing pins.

14. The EUV light source apparatus of claim 13, further comprising:
an actuator coupled to each of the plurality of fixing pins, and configured to move each of the plurality of connection members with respect to each of the plurality of fixing pins in the vertical direction; and
a controller configured to control the actuator,
wherein the controller controls the actuator so that a lower surface of the porous structure is positioned under an upper surface of a tin debris layer formed on the internal wall of the exhaust port.

15. The EUV light source apparatus of claim 14, further comprising a memory unit configured to store height information of the tin debris layer,
wherein the controller, based on the height information of the tin debris layer, controls the actuator so that a distance between the porous structure and the internal wall of the exhaust port is changed, and
wherein the height information of the tin debris layer includes information about a change over time of a height of the tin debris layer.

16. The EUV light source apparatus of claim 14, further comprising a sensor configured to measure a height of the tin debris layer,
wherein the controller:
obtains information about the height of the tin debris layer from the sensor, and
based on information about the height, controls the actuator to change the distance between the porous structure and the internal wall of the exhaust port.

17. The EUV light source apparatus of claim 11,
wherein the porous structure comprises a metal having a lower density than tin, and
wherein a horizontal direction width of each of the plurality of pores is in a range of from about 10 μm to about 10 mm.

18. The EUV light source apparatus of claim 11, further including a heater configured to heat a tin debris layer formed on the internal wall of the exhaust port to a melting point of tin or higher, and located on an outer wall of the exhaust port.

19. An extreme ultra-violet (EUV) light source apparatus comprising:
a chamber body having an internal wall and an outer wall;
a plurality of gas injection holes on a lower region and an upper region of the chamber body to supply a hydrogen gas into the chamber body, and extending from the outer wall of the chamber body to the internal wall of the chamber body;
an exhaust port connected to an inside of the chamber body and configured to exhaust debris to an outside of the chamber body, the exhaust port having an internal wall;
a plurality of first spitting suppression structures on the internal wall of the chamber body in a debris region; and
a plurality of second spitting suppression structures on the internal wall of the exhaust port,
wherein the plurality of first spitting suppression structures include a first porous structure, a plurality of first fixing pins fixed to an internal wall of the debris region, and a plurality of first connection members each configured to connect the first porous structure to a respective one of the plurality of first fixing pins,
wherein the plurality of second spitting suppression structures comprise a second porous structure, a plurality of second fixing pins fixed to the internal wall of the exhaust port, and a plurality of second connection members configured to connect the second porous structure to a respective one of the plurality of second fixing pins, and
wherein the debris region is an entire region of the chamber body except for a region where the plurality of gas injection holes are arranged, and a region where the chamber body is connected to the exhaust port.

20. The EUV light source apparatus of claim 19,
wherein the plurality of first connection members are coupled to the plurality of first fixing pins so that the plurality of first connection members may move with respect to the plurality of first fixing pins in a vertical direction, respectively, and
wherein a distance between the first porous structure and the internal wall of the chamber body is adjustable by moving each of the plurality of first connection members in a vertical direction with respect to each of the plurality of first fixing pins,
wherein the plurality of second connection members are coupled to the plurality of second fixing pins so that the plurality of second connection members may move with respect to the plurality of second fixing pins in a vertical direction, respectively, and
wherein a distance between the second porous structure and the internal wall of the exhaust port is adjustable by moving each of the plurality of second connection members in a vertical direction with respect to each of the plurality of second fixing pins.
